(19) United States
(12) Patent Application Publication
(10) Pub. No.: US 2025/0204548 A1
(43) Pub. Date: Jun. 26, 2025

(54) CANNABIS-FIXATED BEANS AND METHODS OF MAKING SAME

(71) Applicant: Swiss Bihemp Technology, LLC, Miami Lakes, FL (US)

(72) Inventor: Francisco Alexander Bermudez Tápia, Popayán (CO)

(73) Assignee: Swiss Bihemp Technology, LLC, Miami Lakes, FL (US)

(21) Appl. No.: 18/393,129

(22) Filed: Dec. 21, 2023

(51) Int. Cl. A23F 5/46; A23F 5/04

(52) U.S. Cl. CPC A23F 5/465; A23F 5/043

(57) ABSTRACT

The disclosure relates to cannabis-fixated coffee beans or cocoa beans and the method for making said cannabis-fixated beans. The Cannabis plant is cryogenically frozen, ground, and incorporated into a culture medium containing a sugar source such as mucilage and is biocatalyzed by yeast providing a medium for direct extraction and incorporation of cannabis chemicals from the Cannabis plant into raw coffee beans or raw cocoa beans without additional solvents or separate processes. The cannabis-fixated beans produced from the disclosed process exhibits higher cannabinoid, terpene, and flavonoid contents, higher purity, and greater product stability under high roasting and manufacturing temperatures compared to other cannabis-based coffee or cocoa products on the market.

### FIELD

The present disclosure relates to the field of extraction of cannabis chemicals and fixating them into beans (e.g., coffee beans and cocoa beans) and the beans comprising said cannabis chemicals.

### BACKGROUND

Faced with the legalization of the cultivation and consumption of the Cannabis plant in several countries, such as Switzerland and many states in the United States, the use of its cannabinoid compounds in food and beverages has become popular, especially in coffee and cocoa-based products. Although the main psychoactive component of Cannabis plant is tetrahydrocannabinol (THC) such as delta-9-tetrahydrocannabinol (Δ9-THC), a Cannabis plant is known to contain over 400 different psychoactive and non-psychoactive compounds including at least 60 cannabinoids. At least 113 distinct cannabinoids have been isolated from Cannabis plant, although only four (i.e., THCA, CBDA, CBCA, and their common precursor CBGA) have shown to be of biogenetic origin. However, in addition to cannabinoids, the Cannabis plant contains a wide range of terpenes and flavonoids that offer distinct sensory properties such as smell and taste.

Cannabidiol or CBD, is currently the cannabinoid with the widest spectrum of applications, ranging from the therapeutic field to cosmetics, as well as is the most ubiquitous cannabinoid present in edible products. CBD-based edible products have been shown to exhibit anti-inflammatory properties, relieve pain, reduce anxiety, and treat or reduce epilepsy, without the psychoactive side effects induced by THC. However, more recent studies have shown the health benefits of supplementing CBD with micro-doses of THC, to offer enhanced therapeutic effects and thus is also of great interest in edible cannabis products.

The development of food products containing cannabis products and their active ingredients has made their consumption not only easier but also more palatable. As such, several processes have been developed to extract cannabis chemicals including cannabinoids, terpenes/terpenoids, and/or flavonoids from Cannabis plants including: (a) cold pressing for the production of hemp seed oil; (b) microwave extraction of CBD; (c) vegetable oil extraction of CBD, e.g, the Romano-Hazekamp method; (d) petroleum or naphtha extraction, e.g., the Rick Simpson method; (e) ethanol extraction of CBD; and (f) the Super Critical CO₂ extraction. While the above methods have shown to be effective in extracting cannabinoids and terpenes from the Cannabis plant, they are often very slow, need expensive and complex equipment, require chemical modification of cannabinoids and terpenes for solvent compatibility, introduce various potent solvents and gases such as petroleum that may affect the chemical and sensory profile as well as release harmful chemicals into the environment, and often require a post-purification process to remove the extraction medium and to incorporate them into food products. The resulting extracted cannabinoids and terpenes are commonly stabilized in the form of extracted oil, e.g., CBD oil, which is then incorporated into various food products.

For example, food products with cannabis chemicals currently on the market, mainly coffee and cocoa products, are obtained by physically introducing CBD oil to the raw coffee beans or cocoa beans at the latter part of the manufacturing stages. In many cases, extracted cannabinoid oil is sprayed on the surface of the beans, which introduces three critical issues: (1) contamination of the oil layer during the manufacturing and handling process, (2) loss of potency due to exposure to air and moisture, and (3) chemical degradation of the CBD oil under high temperature and pressure during the bean roasting and brewing processes which further reduces cannabinoid potency and produces free radical compounds known to be carcinogenic to human cells.

Accordingly, there is a need for a high-throughput, external solvent-free, economical, environmentally friendly, and more streamlined process for the direct extraction of cannabis chemicals from the Cannabis plant, and their incorporation into products such as coffee beans and cocoa beans that offer high-purity, high-potency, more palatable, and safer products for the consumers.

### SUMMARY

The present disclosure relates generally to cannabis-fixated beans (e.g., coffee beans and cocoa beans) and methods of making cannabis-fixated beans.

In one aspect, the disclosed technology relates to a method of making cannabis-fixated beans, the method comprising: (a) preparing a culture medium comprising a sugar source and a yeast source, wherein fermentation between the sugar source and the yeast source produces alcohol; (b) solubilizing Cannabis plant in the culture medium thereby producing a cannabis-culture medium; (c) incubating raw beans in the cannabis-culture medium thereby producing cannabis-fixated beans; and (d) lowering the temperature of the cannabis-fixated beans. In some embodiments, the fermentation between the sugar source and the yeast source produces from about 8% v/v to about 25% v/v alcohol. In another embodiment, the raw beans comprise coffee beans, cocoa beans, or a combination thereof.

In another aspect, the Cannabis plant is cryogenically frozen and ground into Cannabis plant particles before solubilizing. In some embodiments, the Cannabis plant particles have an average particle diameter from about 50 μm to about 150 μm. In another embodiment, the cannabis-culture medium comprises about 10 wt % to about 35 wt % of the Cannabis plant, based on the total weight of the cannabis-culture medium. In some embodiments, the fermentation of step (a) is conducted for about 12 hours to about 60 hours at a temperature of about 30° C. to about 35° C.

In another aspect, the yeast source comprises a species selected from Pichia, Candida, Saccharomyces, Torulasproa, and combinations thereof. In another embodiment, the sugar source is selected from coffee mucilage, cocoa mucilage, marshmallow root mucilage, slippery elm bark mucilage, chia seeds mucilage, aloe vera mucilage, and combinations thereof. In some embodiment, the yeast source and the sugar source are present in a mass ratio of about 1:300 to about 1:50. Yet in another embodiment, the cannabis-culture medium is mixed with the raw beans in a mass ratio from about 1:5 to about 1:2.

In another aspect, the incubating step of (c) is conducted for about 48 hours to about 720 hours. In some embodiments, the incubating step of (c) is conducted at a temperature range from about 25° C. to about 40° C. In another embodiment, the incubating step of (c) is conducted at a pressure from about 25 PSI to about 150 PSI. In another embodiment, the incubating step of (c) further comprises agitating the cannabis-fixated beans.

In another aspect, the temperature lowering step of (d) is conducted by introducing a cooled water stream to the cannabis-fixated beans, wherein the temperature of the cooled water stream ranges from about 0° C. to about 4° C. In some embodiment, the temperature lowering step of (d) is conducted for about 25 minutes to about 30 minutes. In some embodiments, the temperature lowering step (d) comprises cooling the cannabis-fixated beans to about 0° C. to about 4° C.

In another aspect, the method further comprises raising the temperature of cannabis-fixated beans by combining hot water with the cannabis-fixated beans prior to the temperature lowering step (d), wherein the temperature of the hot water is about 40° C. to about 50° C. In some embodiments, the temperature of the cannabis-fixated beans is raised to about 40° C. to 50° C. In some embodiments, the temperature raising step is conducted for about 25 minutes to about 30 minutes.

In another aspect, the method further comprises drying the cannabis-fixated beans. In some embodiments, the drying is conducted in a condensation dryer. In another embodiment, the drying is conducted for about 18 hours to about 48 hours. In various embodiments, the drying is at a temperature ranging from about 25° C. to about 40° C.

Yet, in another embodiment, disclosed technology relates to cannabis-fixated beans produced from the method disclosed above. In another aspect, the disclosed technology relates to cannabis-fixated beans comprising raw (′offea or Theobroma beans having an inner cell wall that is fixated with cannabis chemicals of Cannabis plant, wherein, the cannabis chemicals comprise cannabinoids, terpenes, flavonoids, or a combination thereof. In another embodiment, the cannabis chemicals do not degrade when the beans are roasted at a temperature of about 100° C. to about 250° C.

The details of one or more aspects of the disclosure are set forth in the description below. Other features, objects, and advantages of the technique described in this disclosure will be apparent from the description and from the claims.

### BRIEF DESCRIPTION OF THE DRAWINGS

The drawing provided herewith illustrates particular embodiments of the present disclosure and do not limit the scope of the present disclosure. The drawings are not to scale and are intended for use in conjunction with the explanations in the following detailed description.

FIG. 1 is a schematic of an example of producing cannabis-fixated coffee beans or cocoa beans according to the present disclosure.

FIG. 2 is a side view and internal components of the bioreactor according to the present disclosure.

### DETAILED DESCRIPTION

The disclosed technology is directed to cannabis-fixated beans (e.g., coffee beans and cocoa beans) and methods of making cannabis-fixated beans. For example, the disclosed methods include yeast-assisted extraction of cannabinoids, terpenes, and flavonoids from a Cannabis plant or flower without the use of solvents or additional processes. The disclosed technology preserves the psychoactive, non-psychoactive, and sensory properties, i.e., smell, taste, and texture, of the cannabis-fixated beans under high manufacturing and roasting temperatures that would typically degrade Cannabis plant chemicals.

As used herein, a “coffee plant” refers to any plants of the genus (′offea. The coffee plant may include any physical part of the plant material, including, but not limited to the outer skin, pulp, mucilage, parchment, silver skin, beans/seed, center cut, fruit, and combinations thereof. Similarly, as used herein, “cocoa plant” may refer to any plants of the genus Theobroma. The Cocoa plant may include any physical part of the plant material, including but not limited to the pericarp, mesocarp, endocarp, pulp, beans/seeds, and combinations thereof.

As used herein, “raw beans” refer to beans that have physically separated from a plant—e.g., a coffee or cocoa plant—but have not been subjected to roasting. For instance, “raw coffee beans” or “raw cocoa beans” refers to the beans of coffee plants or cocoa plants, respectively, that have been physically separated from the rest of the plant but have yet to be roasted.

As used herein, a “(′annabis plant” refers to a genus of flowering plants that includes one or more of the following species: Cannabis sativa, Cannabis indica, and Cannabis ruderalis. The Cannabis plant may include any physical part(s) of the plant material, including but not limited to the leaf, bud, flower, trichome, seed, stem, roots, and combinations thereof. Similarly, the term “cannabis chemical” may include any class of chemicals that are in the makeup of the Cannabis plant including but not limited to cannabinoids, terpenes, flavonoids, and combinations thereof.

As used herein, a “cannabinoid” or “cannabinoid compound” refers to a class of chemical compounds found in a Cannabis plant that act on cannabinoid receptors on cells that repress neurotransmitter release in the brain. In various embodiments, cannabinoids may include, but are not limited to cannabidiol (CBD) type (e.g., cannabidiolic acid), cannabichromene (CBC) type (e.g., cannabichromenic acid), cannabigerol (CBG) type (e.g., cannabigerolic acid), Δ⁹-trans-tetrahydrocannabinol (Δ⁹-THC) type (e.g., Δ⁹-tetrahydrocannabinolic acid), Δ⁸-trans-tetrahydrocannabinol (Δ⁸-THC) type, cannabicyclol (CBL) type, cannabielsoin (CBE) type, cannabinol (CBN) type, cannabinodiol (CBND) type, cannabitriol (CBT) type, cannabigerolic acid (CBGA), cannabigerolic acid monomethylether (CBGAM), cannabigerol (CBG), cannabigerol monomethylether (CBGM), cannabigerovarinic acid (CBGVA), cannabigerovarin (CBGV), cannabichromenic acid (CBCA), cannabichromene (CBC), cannabichromevarinic acid (CBCVA), cannabichromevarin (CBCV), cannabidiolic acid (CBDA), cannabidiol (CBD), cannabidiol monomethylether (CBDM), cannabidiol-C₄ (CBD-C₄), cannabidiolic acid-C₄ (CBDA-C₄), cannabidivarinic acid (CBDVA), cannabidivarin (CBDV), cannabidiorcol (CBD-C₁), Δ⁹-tetrahydrocannabinolic acid A (THCA-A), Δ⁹-tetrahydrocannabinolic acid B (THCA-B), Δ⁹-tetrahydrocannabinol (THC), Δ⁹-tetrahydrocannabinolic acid-C₄ (THCA-C₄), Δ⁹-tetrahydrocannabinol-C₄ (THC-C₄), Δ⁹-tetrahydrocannabivarinic acid (THCVA), Δ⁹-tetrahydrocannabivarin (THCV), Δ⁹-tetrahydrocannabiorcolic acid (THCA-C₁), Δ⁹-tetrahydrocannabiorcol (THC-C₁), Δ⁷-cis-iso-tetrahydrocannabivarin, Δ⁸-tetrahydrocannabinolic acid (Δ⁸-THCA), Δ⁸-tetrahydrocannabinol (Δ⁸-THC), cannabicyclolic acid (CBLA), cannabicyclol (CBL), cannabicyclovarin (CBLV), cannabielsoic acid A (CBEA-A), cannabielsoic acid B (CBEA-B), cannabielsoin (CBE), cannabielsoinic acid, cannabicitranic acid, cannabinolic acid (CBNA), cannabinol (CBN), cannabinol methylether (CBNM), cannabinol-C₄, (CBN-C₄), cannabivarin (CBV), cannabinol-C₂ (CNB-C₂), cannabiorcol (CBN-C₁), cannabinodiol (CBND), cannabinodivarin (CBVD), cannabitriol (CBT), 10-ethyoxy-9-hydroxy-delta-6a-tetrahydrocannabinol, 8,9-dihydroxyl-delta-6a-tetrahydrocannabinol, cannabitriolvarin (CBTV), dehydrocannabifuran (DCBF), cannabifuran (CBF), cannabichromanon (CBCN), cannabicitran (CBT), 10-oxo-delta-6a-tetrahydrocannabinol (OTHC), delta-9-cis-tetrahydrocannabinol (cis-THC), 3,4,5,6-tetrahydro-7-hydroxy-alpha-alpha-2-trimethyl-9-n-propyl-2,6-methano-2H-1-benzoxocin-5-methanol (OH-iso-HHCV), cannabiripsol (CBR), and trihydroxy-delta-9-tetrahydrocannabinol (triOH-THC). Cannabinoids may be acidic or neutral depending on whether or not they have a carboxylic acid group present on the phenyl ring core of the cannabinoid. For example, THCA and CBDA are acidic cannabinoids, but THC and CBD are neutral cannabinoids.

As used herein, “terpenes” or “terpenoid” refers to a class of chemical compounds found in a Cannabis plant that contribute to the Cannabis plant's aromatic and flavor profile. Chemically, terpenes may include hydrocarbons or derivatives thereof, found as a natural product and biosynthesized by oligomerization of isoprene units. Terpenes can be acyclic, monocyclic, bicyclic, or multicyclic and contribute to the aromatic and flavor profile of Cannabis plants. In various embodiments, terpenes may include but are not limited to myrcene, beta-caryophyllene, limonene, linalool, pinene, humulene, terpinolene, alpha-bisabolol, eucalyptol, geraniol, citronellol, nerol, terpineol, farnesene, borneol, ocimene, nerolidol, guaiol, valencene, 3-carene, phytol, sabinene, phellandrene, fenchol, menthol, terpinene, isoborneol, cymene, pulegone, caryophyllene epoxide, and the like. Similarly, as used herein, “flavonoids” refers to a class of diverse chemical compounds found in a Cannabis plant that contribute to the Cannabis plant's color, flavor, and pharmacological profile. In various embodiments, flavonoids may include but are not limited to cannflavin A, cannflavin B, cannflavin C, quercetin, kaempferol, apigenin, orientin, vitexin, and the like.

As used herein, the term “fixation” or “fixating,” refers to entrapping the extracted chemicals from the Cannabis plant, i.e., cannabis chemicals such as terpenoids, cannabinoids, and flavonoids, in the internal lipid structures of the inner cell wall of the raw beans by the disclosed method thereby protecting the cannabis chemicals from degrading during the bean roasting process and preserving the chemical, physical, structural, therapeutic, and sensory properties of the cannabis chemicals.

Throughout this disclosure, various terms are used such as “first,” “second,” and the like. These terms are words of convenience in order to distinguish between different elements, and such terms are not intended to be limiting as to how the different elements may be utilized.

As used herein, “about” or “approximately,” when used in connection with a numeric value, is intended to include values that are close to, but not exactly, the number to the nearest significant figure. For example, in some embodiments, numbers “about” or “approximately” between 3.1 and 3.4 may be rounded to 3, and numbers “about” or “approximately” between 3.5 and 3.9 may be rounded to 4. Alternatively, the term “about” or “approximately” may also include values that are within +/−10 percent of the stated value.

Reference to various embodiments or examples of the disclosure does not limit the scope of the claims attached hereto. Any examples set forth in this specification are not intended to be limiting and merely set forth some of the many possible embodiments for the appended claims.

The present disclosure provides a high-efficiency, industrially scalable, environmentally friendly, and streamlined direct extraction of cannabis chemicals including cannabinoids, terpenes, and flavonoids from the Cannabis plant, and their incorporation into the raw coffee beans or raw cocoa beans, without the need for complex extraction process that requires potent or poisonous solvents or gases. The process involves first producing a culture medium comprising a sugar source that is inoculated with yeast, that is used to extract cannabis chemicals including cannabinoids, terpenes, and flavonoids, from a Cannabis plant. The culture medium according to the present disclosure generally contains yeast source to sugar source in a mass ratio of about 1:300. Non-limiting examples of the sugar source to yeast mass ratio may include about 1:250, 1:200, 1:150, 1:100, or 1:50.

In some embodiments, the sugar source that is used to produce culture medium may comprise mucilage. In some embodiments, mucilage from the plants of the genus Coffea, i.e., coffee, and Theobroma, i.e., cocoa, is inoculated with yeast to activate the first biocatalysis or enzymatic fermentation process. It should be understood that essentially any mucilage with sugar content capable of being inoculated with yeast and undergoing an enzymatic fermentation process may be used. In various embodiments, substituted sugar source may include but is not limited to Althaea officinalis (marshmallow root), Ulmus rubra (slippery elm bark), Salvia hispanica (chia seeds), or Aloe vera (aloe). In other embodiments, a substance with a similar structure and molecular size to mucilage may be substituted in place of mucilage. In various embodiments, a suitable substitute of equal structure and molecular size may include a substance comprising sugars including glucose, galactose, lactose; and acetic acid.

In various embodiments, any yeast capable of the fermentation process may be used. In various embodiments, the yeast may include, but are not limited to yeast species from the genus Pichia, Candida, Saccharomyces, or Torulasproa. In embodiments, the yeast capable of producing from about 8% v/v and about 25% v/v, about 13% v/v and about 22% v/v, or about 15% v/v and about 20% % v/v alcohol, is resistant to high levels of osmotic pressure up to about 125 MPa and is thermotolerant up to about 50° C. may be used.

The culture medium produced from a sugar source and a yeast source according to the present disclosure is then incorporated with the Cannabis plant for solubilization in the culture medium and extraction of cannabis chemicals including cannabinoids, terpenes, and flavonoids. In various embodiments, the Cannabis plant may be cryogenically frozen, then ground, i.e., cryogenically ground, to ensure that the Cannabis plant is adequately crystallized and fragmented while retaining the chemical properties of the Cannabis plant. Cryogenically freezing the Cannabis plant in this manner preserves the volatile chemicals within the cellular structure of the plant and prevents thermal degradation during grinding, resulting in uniform particle size while maintaining the chemical, structural, and sensory characteristics of the cannabis chemicals.

In various embodiments, liquid nitrogen or liquid argon may be used to cryogenically freeze the Cannabis plant during the grinding process. In various embodiments, the cryogenic grinding process may be accomplished by a technique that imparts repetitive shear events to mechanically breakdown the cryogenically frozen Cannabis plants into smaller crystal particles including, but not limited to ball milling, solenoid activated steel impactor, or grinding wheel. In some embodiments, the cryogenic grinding is achieved at a temperature range from about −80° C. and about −200° C., about −100° C. and about −180° C., about −120° C. and about −160° C., or about −140° C. and about −150° C.

In various embodiments, the average particle diameter size of the cryogenically ground Cannabis plant particles may range from about 50 μm and about 200 μm, about 75 μm and about 175 μm, or about 100 μm and about 150 μm. After cryogenic grinding of the Cannabis plants, well-crystallized (′annabis plant particles are uniformly incorporated and solubilized in the culture medium. In various embodiments, the cannabis-culture medium typically contains between about 10 wt % and about 35 wt %, about 15 wt % and about 30 wt %, or about 20 wt % and about 25% of the total weight of the cryogenically ground (′annabis plant particles.

The cryogenically ground Cannabis plant particles are incorporated into the culture medium and incubated to drive the first biocatalysis process. Biocatalysis, or enzymatic fermentation process of cryogenically ground (′annabis plant particles incubated in the culture medium may be accomplished by generating bioavailable carbon sources in the sugar source by the inoculation of the sugar source with yeast, for the natural production of aldehydes, esters, and alcohols. The naturally produced alcohol during the fermentation process provides good solubility with water and oily compounds of the Cannabis plant, such as cannabinoids, terpenes, and flavonoids. In various embodiments, the first biocatalysis process produces from about 8% v/v and about 25% v/v, about 13% v/v and about 22% v/v, or about 15% v/v and about 20% % v/v alcohol, which enables the solubilization of cannabis chemicals, as well as enables the breakdown of the glandular trichomes of the Cannabis plant without the need for added chemicals. In some embodiments, the enzymatic process may be accelerated by modulating the pressure or temperature that provides a concentration between about 8% v/v and about 25% v/v, about 13% v/v and about 22% v/v, or about 15% v/v and about 20% % v/v alcohol in the culture medium.

In various embodiments, the enzymatic extraction of the cannabis chemicals from the Cannabis plant in yeast-activated sugar source may be conducted for a period in a range of about 12 hours and about 60 hours, about 24 hours and about 48 hours, or at about 36 hours, depending on but not limited to the cannabis chemical profile of the Cannabis plant, type of the sugar source, enzymatic properties of the yeast, or the ratio component of the yeast to sugar source to Cannabis plant. In some embodiments, the extraction of the cannabis chemicals in the cannabis-culture medium may be conducted at a temperature range of about 20° C. and about 35° C., about 25° C. to about 30° C., about 20° C. and about 25° C., about 25° C. and about 30° C., or about 30° C. and about 35° C. The resulting enzymatic reaction produces a cannabis-culture medium with high availability of high-purity, chemically unmodified cannabinoids, terpenes, and flavonoids.

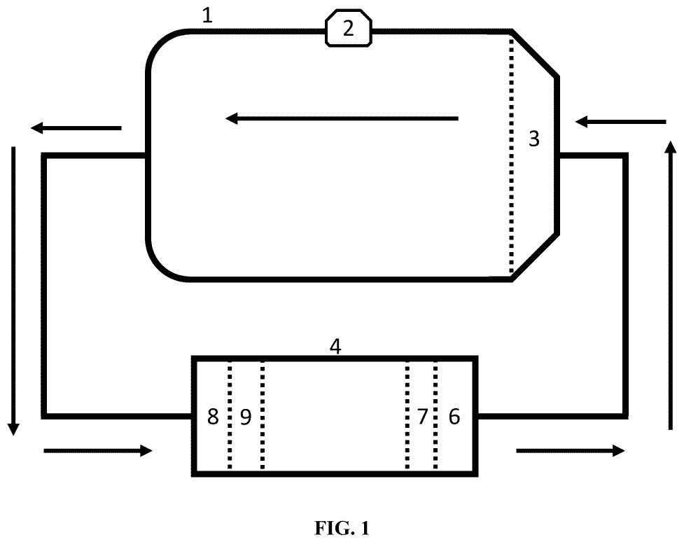

The cannabis-culture medium is then mixed with the raw coffee beans or the raw cocoa beans and incubated to drive a second biocatalysis process for fixating the extracted cannabis chemicals within the internal cellular structure of the raw coffee bean or the raw cocoa bean. FIG. 1 depicts an example of the process for producing cannabis-fixated coffee or cocoa beans.

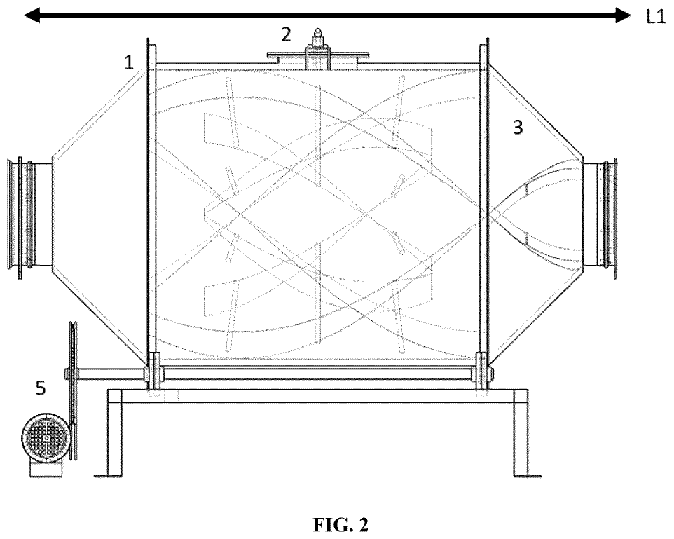

As shown in FIG. 1, the raw coffee beans or the raw cocoa beans are loaded into bioreactor 1 through loading gate 2 and are mixed with the cannabis-culture medium and incubated to drive the second biocatalysis process. In various embodiments, the cannabis-culture medium is mixed with the raw coffee beans or raw cocoa beans at a ratio of about 1:2, about 1:3, about 1:4, or about 1:5. As seen in FIG. 2, the internal cavity of the bioreactor 1 contains a series of homogenization blades that agitate the raw coffee beans or the raw cocoa beans for even distribution in the culture medium. In various embodiments, bioreactor 1 may be rotated along the longitudinal axis (L1) by a drive system 5 to rotate the homogenization blades from about 0.2 rotations per minute (rpm) and 2.0 rpm, about 0.5 rpm and about 1.5 rpm, about 0.75 rpm and about 1.25 rpm, or at about 1 rpm to agitate the raw coffee beans or raw cocoa beans to ensure that all of the raw coffee beans or raw cocoa beans come in contact with the cannabis-culture medium. In some embodiments, a timer is programmed so that the direction of the rotation is changed for better homogenization of the culture medium with the raw coffee beans or the raw cocoa beans. In various embodiments, the process may be batch loaded or continuously loaded through loading gate 2. The use of internal pressure in the bioreactor along with the temperature control, and the perturbation caused by the rotation of the blades results in the fixation, i.e., penetration, of the cannabis chemicals in the internal lipid structure of the inner cell wall of the raw coffee beans or the raw cocoa beans.

In various embodiments, the bioreactor may be operated in a pressure range between about 25 pound-force per square inch (PSI) and about 150 PSI, about 50 PSI and about 125 PSI, or about 75 PSI and about 100 PSI. In various embodiments, the bioreactor may be operated in a pressure range between about 25 PSI and about 50 PSI, about 50 PSI and about 75 PSI, about 75 PSI and about 100 PSI, about 100 PSI and about 125 PSI, or about 125 PSI and about 150 PSI. In various embodiments, the bioreactor may be operated in a range between about 25 PSI and about 35 PSI, to drive the fixation of the cannabis chemicals in the raw beans.

In some embodiments, the internal temperature of the bioreactor during the second biocatalysis process may range between about 25° C. and about 40° C., about 30° C. and about 35° C., about 25° C. and about 30° C., about 30° C. and about 35° C., or about 35° C. and about 40° C. In various embodiments, the second biocatalysis process may be conducted for a period from about 48 hours and about 720 hours, about 60 hours and about 600 hours, about 72 hours and about 480 hours, about 84 hours and about 360 hours, about 96 hours and about 240 hours, or about 108 hours and about 120 hours, depending on but not limited to the desired sensory characteristic and the cannabis chemical concentrations, the type of the raw coffee beans or the raw cocoa beans, or the ratio of the culture medium to raw coffee beans or the raw cocoa beans.

After the completion of the second biocatalysis process resulting in the fixation of the cannabinoids, terpenes, and flavonoids into the inner cell wall structures of the raw coffee beans or the raw cocoa beans, the cannabis-fixated coffee beans or the cocoa beans are subjected to a thermal shock wash with cold water stream in bioreactor 1. In various embodiments, thermal shock comprises rapidly reducing the temperature of the cannabis-fixated coffee beans or the cocoa beans by a stream of cooled, near-freezing water. In various embodiments, prior to reducing the temperature of the cannabis-fixated coffee beans or the cocoa beans, the temperature may be increased to a range from about 40° C. to about 50° C. by introducing the reactor with a hot water stream ranging from about 40° C. to about 50° C. for about between 25 minutes to about 30 minutes, then introducing near-freezing, cooled water stream ranging between about 0° C. about 4° C., to reduce the temperature of the beans to about 0° C. to about 4° C. In some embodiments, the cooled water is introduced for about 25 minutes to about 30 minutes. In various embodiments, the temperature of the beans may be reduced at a rate of about 1° C./min to about 2° C./min, 1.2° C./min to about 1.8° C./min, or 1.4° C./min to about 1.6° C./min. The thermal shock wash of the coffee beans or the cocoa beans ensures that the fixated cannabis chemicals are sealed in the internal lipid structures of the inner cell wall thereby preserving their chemical, physical, structural, therapeutic, and sensory properties.

The extraction of cannabis chemicals such as cannabinoids, terpenes, and flavonoids and their fixation in the internal lipid structure of the inner cell wall in an unroasted state prevents degradation of these chemicals when the beans are subsequently roasted at a temperature range from about 100° C. and 250° C. In various embodiments, Coffea beans may be roasted at a temperature range from about 170° C. and about 250° C., about 185° C. and about 235° C., about 200° C. and about 220° C., or at a temperature of about 210° C. In various embodiments, the Theobroma beans may be roasted at a temperature range from about 115° C. and about 165° C., about 130° C. and about 150° C., or at a temperature of about 140° C.

After the thermal-shock process, the cannabis-fixated beans are dried in bioreactor 1 via condensing unit 4 without any additional heat source. FIG. 1 depicts the direction of the air and moisture flow during the drying process. Condenser coil 7 and circulation fan 6, located on the first side of the condensing unit 4, direct the airflow to the discharge cone 3, and through bioreactor 1, in which the moisture in the air and from the thermally shocked beans is circulated to evaporator coil unit 8 and collected at moisture outlet 9, both located on a second side of condensing unit 4.

The absence of additional heat during the condensation drying prevents heat-induced volatilization of the cannabis chemicals in the beans and preserves active chemical and aromatic properties of the final product as well as premature roasting of the beans while completely removing the moisture from the beans and air thus providing a higher purity, higher cannabis chemical content, and more shelf-stable product. In various embodiments, condensation drying is carried out for a period from about 18 hours and about 48 hours, about 24 hours to 42 hours, or about 30 hours to 36 hours. Throughout the condensation drying step, the temperature of the bioreactor is maintained in a range from about 25° C. and about 40° C., or about 30° C. to about 35° C. After condensation drying, condensing unit 4 is disconnected from bioreactor 1 at discharge gate 3 and the dried cannabis-fixated beans are removed from the bioreactor ready for packaging, distribution, and consumption. The fixation of cannabis chemicals such as cannabinoids, terpenes, and flavonoids in the beans in an unroasted state prevents degradation of these chemicals when the beans are subsequently roasted at high temperatures above 100° C., e.g., 250° C. for coffee beans and about 160° C. for cocoa beans, thereby preserving the chemical, physical, structural, therapeutic, and sensory properties of the cannabis chemicals.

Although the presently disclosed technology has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the following claims.

### EXAMPLES

The present disclosure is next described by means of the following examples. The use of these and other examples anywhere in the specification is illustrative only, and in no way limits the scope and meaning of the disclosure or of any exemplified form. Likewise, the disclosure is not limited to any particular preferred embodiments described herein. Indeed, modifications and variations of the disclosure may be apparent to those skilled in the art upon reading this specification and can be made without departing from its spirit and scope. The disclosure is therefore to be limited only by the terms of the claims, along with the full scope of equivalents to which the claims are entitled.

### Example 1: Preparation of Cannabis-Culture Medium

100 kilograms (kg) of whole Cannabis plants were cryogenically frozen (cryo-frozen) and ground to an average particle size of between 100 μm and 150 μm. The cryogenically ground (cryo-ground) Cannabis plant particles were mixed in a culture medium comprising 300 kg coffee mucilage and 1 kg of yeast to solubilize the cryo-ground Cannabis plant particles and to produce cannabis-culture medium. The temperature of the biocatalysis reaction was carried out at 35° C. After 48 hours, 20% v/v ethanol was produced which solubilized the cryo-ground Cannabis plant particles, thereby producing a cannabis-culture medium.

### Example 2: Fixating Cannabis Chemicals in Raw Coffee Beans

1000 kg of raw, unroasted coffee beans were placed in a Cephiro Coffee fermenter & Dryer machine and mixed with 400 kg of cannabis-culture medium. During the mixing process, the homogenization blades within the holding chamber were rotated at 1 rpm to ensure all of the raw coffee beans were covered with cannabis-culture medium. During the mixing process, the temperature of the chamber was maintained at 37° C., and the pressure in a range from 25 PSI to 35 PSI to allow cannabis chemicals in the cannabis-culture medium to penetrate the outer layer of the raw coffee beans into the internal lipid structures of the inner cell wall. The mixing process was performed for 720 hours to ensure that all of the coffee beans in the bioreactor were fixated with cannabis chemicals.

### Example 3: Thermal-Shocking and Drying the Cannabis-Fixated Coffee Beans

The cannabis-fixated coffee beans were then washed by first flowing a continuous stream of warm 45° C. water over the cannabis-fixated coffee beans for 25 minutes until the cannabis-fixated coffee beans were at 45° C. Afterward, a continuous stream of near-freezing, glycol-cooled water at 4° C. was washed over the cannabis-fixated coffee beans for 25 minutes until the temperature of the cannabis-fixated coffee beans was lowered to 4° C.

After washing, the cannabis-fixated coffee beans were dried in the bioreactor for 36 hours using a condensation drying module coupled to the bioreactor. During the drying process, the air within the bioreactor was maintained at 40° C. without any additional heat input, which completely removed residual moisture in the chamber and from the cannabis-fixated coffee beans without roasting the coffee beans. After the drying process, the cannabis-fixated coffee beans were removed from the bioreactor, packed in a vacuum-sealed grain bag, and stabilized in the warehouse for 11-15 days until transport for sale and distribution.

### Example 4: Chemical Profile of the Cannabis-Fixated Coffee Beans

The cannabis-fixated coffee beans produced from the above method was analyzed by high-performance liquid chromatography (HPLC) by an independent lab to determine the chemical profile and cannabinoid potency of the beans. Table 1 below summarizes the cannabinoid profile of the cannabis-fixated coffee beans produced from the above example method. The primary detected cannabis chemicals are Cannabidiol (CBD) and Δ⁹-Tetrahydrocannabinol (Δ⁹ -THC) at 0.0443 wt % and <0.01 wt % respectively, indicating efficient extraction and fixation of the cannabis chemicals.

TABLE 1
Cannabinoid profile of cannabis-fixated coffee beans.

| Cannabinoids | Quantity | Detection Limit |
|---|---|---|
| Cannabidiol (CBD) | 0.0443 wt % | 0.001 wt % |
| Δ⁹-Tetrahydrocannabinol (Δ⁹-THC) | <0.01 wt % | 0.001 wt % |
| TOTAL CANNABINOIDS | 0.0443 wt % | 0.001 wt % |

In the same lab, additional analysis was performed to determine the degree of biological, organic, and inorganic impurities present in the cannabis-fixated coffee beans prepared from the disclosed method. As shown in Table 2, the cannabis-fixated coffee beans are free of biological microbials and organic mycotoxins, and contains only trace amounts of inorganic heavy metals, indicating high-grade, pure extraction of the cannabis chemicals.

TABLE 2
Impurity analysis of cannabis-fixated coffee beans.

| Impurity Type | Analyte | Quantity | Detection Limit |
|---|---|---|---|
| Biological | Escherichia coli | *NP | N/A |
| Microbials | Salmonella | NP | N/A |
| | Aspergillus Flavus | NP | N/A |
| | Aspergillus Niger | NP | N/A |
| | Aspergillus Terreus | NP | N/A |
| Organic | Aflatoxin G1 | **ND | 0.0016 ppm |
| Mycotoxins | Aflatoxin G2 | ND | 0.0012 ppm |
| | Aflatoxin B1 | ND | 0.0012 ppm |
| | Aflatoxin B2 | ND | 0.0012 ppm |
| | Ochratoxin A+ | ND | 0.002 ppm |
| Inorganic | Arsenic | ND | 0.02 ppm |
| Heavy Metals | Cadmium | ND | 0.02 ppm |
| | Mercury | <0.04 ppm | 0.02 ppm |
| | Lead | <0.04 ppm | 0.02 ppm |

*NP = Not present
**ND = Not detected

Conclusion: The disclosed method of solvent-free, yeast-mediated extraction and fixation of the cannabis chemicals produces high potent, high purity cannabis-fixated beans without any biological, organic, or inorganic impurities. Furthermore, the fixation of cannabis chemicals within the inner lipid structure of the beans in an unroasted state prevents degradation of these chemicals when the beans are subsequently roasted at high temperatures above 100° C., e.g., 250° C. for coffee beans and about 160° C. for cocoa beans, thereby preserving the chemical, physical, structural, therapeutic, and sensory properties of the cannabis chemicals.

The foregoing merely illustrates the principles of the disclosure. Any examples set forth in this specification are not intended to be limiting and merely set forth some of the many possible embodiments for the appended claims. Those skilled in the art will readily recognize various modifications and changes that may be made without following the example embodiments and applications illustrated and described herein, and without departing from the true spirit and scope of the following claims.

All references cited and/or discussed in this specification are incorporated herein by reference in their entirety and to the same extent as if each reference was individually incorporated by reference.

What is claimed is:

1. A method of making cannabis-fixated beans, the method comprising:
(a) preparing a culture medium comprising a sugar source and a yeast source, wherein fermentation between the sugar source and the yeast source produces alcohol;
(b) solubilizing Cannabis plant in the culture medium thereby producing a cannabis-culture medium;
(c) incubating raw beans in the cannabis-culture medium thereby producing cannabis-fixated beans; and
(d) lowering the temperature of the cannabis-fixated beans.

2. The method of claim 1, wherein the fermentation between the sugar source and the yeast source produces from about 8% v/v to about 25% v/v alcohol.

3. The method of claim 1, wherein the raw beans comprise coffee beans, cocoa beans, or a combination thereof.

4. The method of claim 1, wherein the Cannabis plant is cryogenically frozen and ground into Cannabis plant particles before the solubilizing.

5. The methods of claim 4, wherein the Cannabis plant particles have an average particle diameter from about 50 μm to about 200 μm.

6. The method of claim 1, wherein the cannabis-culture medium comprises about 10 wt % to about 35 wt % of the Cannabis plant, based on total weight of the cannabis-culture medium.

7. The method of claim 1, wherein the fermentation of step (a) is conducted for about 12 hours to about 60 hours at a temperature of about 20° C. to about 35° C.

8. The method of claim 1, wherein the yeast source comprises a species selected from Pichia, Candida, Saccharomyces, Torulasproa, and combinations thereof.

9. The method of claim 1, wherein the sugar source is selected from coffee mucilage, cocoa mucilage, marshmallow root mucilage, slippery elm bark mucilage, chia seeds mucilage, aloe vera mucilage, and combinations thereof.

10. The method of claim 1, wherein the yeast source and the sugar source are present in a mass ratio of about 1:300 to about 1:50.

11. The method of claim 1, wherein the cannabis-culture medium is mixed with the raw beans in a mass ratio from about 1:5 to about 1:2.

12. The method of claim 1, wherein step (d) is conducted by introducing a cooled water stream to the cannabis-fixated beans, wherein temperature of the cooled water stream ranges from about 0° C. to about 4° C.

13. The method of claim 1, further comprising raising the temperature of cannabis-fixated beans by combining hot water with the cannabis-fixated beans prior to step (d), wherein temperature of the hot water is about 40° C. to about 50° C.

14. The method of claim 13, wherein the temperature of the cannabis-fixated beans is raised to about 40° C. to 50° C.

15. The method of claim 13, wherein the temperature raising step is conducted for about 25 minutes to about 30 minutes.

16. The method of claim 1, further comprising drying the cannabis-fixated beans after step (d).

17. The method of claim 16, wherein the drying is conducted for about 18 hours to about 48 hours.

18. The method of claim 16, wherein the drying is at a temperature ranging from about 25° C. to about 40° C.

19. A cannabis-fixated beans comprising raw Coffea or Theobroma beans having an inner cell wall that is fixated with cannabis chemicals of Cannabis plants, wherein the cannabis chemicals comprise cannabinoids, terpenes, flavonoids, or a combination thereof.

20. The cannabis-fixated beans of claim 19, wherein the cannabis chemicals do not degrade when the beans are roasted at a temperature of about 100° C. to about 250° C.
